(19) United States
(12) Patent Application Publication
(10) Pub. No.: US 2015/0290998 A1
(43) Pub. Date: Oct. 15, 2015

(54) SYSTEMS AND METHODS FOR CONDITIONING AN ENVIRONMENT

(71) Applicant: Alliance for Sustainable Energy, LLC, Golden, CO (US)

(72) Inventors: Jason LUSTBADER, Boulder, CO (US); Cory KREUTZER, Arvada, CO (US)

(21) Appl. No.: 14/682,874

(22) Filed: Apr. 9, 2015

Related U.S. Application Data
(60) Provisional application No. 61/977,167, filed on Apr. 9, 2014.

(51) Int. Cl. B60H 1/00; B60H 1/24

(52) U.S. Cl. CPC B60H 1/00014; B60H 1/00028; B60H 1/00035; B60H 1/244; B60H 2001/00185

(57) ABSTRACT

Systems and methods for providing conditioning to a space within an environment are provided. Such a system may include a solid boundary, at least one air supply aperture configured to direct a conditioned airflow towards the solid boundary, and at least one air return aperture configured to receive a return airflow. At least one of the conditioned airflow or the return airflow may create an air boundary, such that the air boundary and the solid boundary define the space within the environment. At least a portion of the conditioned airflow may enter the space, and at least a portion of the return airflow may exit the space, thereby conditioning the space.

### CROSS-REFERENCE TO RELATED APPLICATIONS

This application claims priority to U.S. Provisional Application No. 61/977,167, filed Apr. 9, 2014, the contents of which are incorporated by reference in their entirety.

### CONTRACTUAL ORIGIN

The United States Government has rights in this invention under Contract No. DE-AC36-08GO28308 between the United States Department of Energy and the Alliance for Sustainable Energy, LLC, the Manager and Operator of the National Renewable Energy Laboratory.

### BACKGROUND

Long-haul trucks typically travel more than 500 miles per day. Because these trucks often travel for many consecutive days, their cabs typically include a sleeping/living compartment, which is a space in the cab that may be separate from the driving compartment. The sleeping/living compartment affords the driver (and/or co-driver or passenger) a comfortable area to rest, relax, and sleep when not driving. The sleeping/living compartment may include a separate seating area, a sleeping area, storage space, an entertainment console, and a separate lighting system. A long-haul truck's cab also typically includes at least one climate control system. The climate control system may include components to supply cooled air, heated air, humidified air, and/or dehumidified air, as well as the equipment needed to circulate the conditioned air throughout the cab. In some cases, a truck's sleeper/living compartment and the driving compartment, collectively referred to herein as the cab, may share a climate control system. Alternatively, the climate control system for the sleeper/living compartment may be independent from the climate control system for the driving compartment. In many cases, the truck's main engine provides the power required to operate these climate control systems.

However, the operation of a long-haul truck's climate control systems is inefficient and consumes large quantities of fuel. In the United States alone, long-haul trucks consume approximately 667 million gallons of fuel annually simply by idling during rest periods (e.g. while the driver sleeps). Providing conditioned air (e.g. heated, cooled, humidified, and/or dehumidified air) to the cab of the truck is a significant contributor to this wasteful fuel consumption, and has spurred city, state, and federal governments to develop regulations and incentives to combat the problem.

To take advantage of regulatory incentives and to avoid costly fines, truck manufacturers and operators need improved truck compartment climate control methods and technologies. For example, instead of operating the main engine, batteries or smaller auxiliary generators may be used to power the climate control system supplying conditioned air to the cab and/or sleeper compartment during rest periods. In addition, the total power required to maintain the climate in the cab may be reduced by minimizing the thermal loads required to maintain the cab environment. This may be accomplished by improving the efficiency of the conditioning systems and/or by minimizing thermal losses from the cab to the outside environment. However, these approaches are often costly and can add weight to the truck, thereby decreasing fuel efficiency and increasing transportation costs. Physically partitioning the sleeper compartment from the driving compartment may reduce the amount of energy required for climate control by reducing the space needing air conditioning. However, such physical partitioning significantly reduces the driver's living space and may result in a sense of confinement and lower the driver's overall comfort level.

A need remains for methods and systems that reduce energy use during periods of engine idling in long-haul trucks, while simultaneously providing a comfortable and usable living space within the cab.

### SUMMARY OF THE INVENTION

According to an aspect of the present invention, a system for conditioning a space within an environment is provided. The system includes a solid boundary, at least one air supply aperture configured to direct a conditioned airflow towards the solid boundary, and at least one air return aperture configured to receive a return airflow. Further, the conditioned airflow and/or the return airflow creates an air boundary, such that the air boundary and the solid boundary define the space within the environment. At least a portion of the conditioned airflow enters the space, and at least a portion of the return airflow exits the space, thereby providing the conditioning.

The solid boundary may include a solid surface. The at least one air supply aperture may include at least one hole, slit, slot, nozzle, vent, and/or register. The conditioned airflow may have a flow rate ranging from about 1 CFM to about 1000 CFM. The conditioned airflow may be divided into a plurality of airflows by an air supply aperture including a plurality of air supply apertures. Each of the plurality of smaller airflows may have a gas velocity ranging from about 1 ft/sec to about 100 ft/sec.

The conditioned airflow may be conditioned by heating, cooling, humidifying, and/or dehumidifying. The air return aperture may include a hole, a slit, a slot, a nozzle, a vent, and/or register. The air return aperture may receive a return airflow with a flow rate ranging from about 1 CFM to about 1000 CFM.

The portion of the conditioned airflow entering the space may range from about 1 vol % to about 100 vol % of the conditioned airflow. The portion of return airflow exiting the space may range from about 1 vol % to about 100 vol % of the return airflow. The space may be configured to accommodate a human lying substantially in a prone position within at least a portion of the space.

According to another aspect of the present invention, a method for conditioning a space within an environment is provided. The method includes supplying a conditioned air flow, directing the conditioned airflow towards a solid boundary, receiving a return airflow, and defining the space with the conditioned airflow, the return airflow, and the solid boundary. The conditioned airflow includes a portion that is directed into the space and the return airflow includes a portion that is received from the space, thereby conditioning the space.

Other objects, advantages, and novel features of the present invention will become apparent from the following detailed description of the invention when considered in conjunction with the accompanying drawings.

### BRIEF DESCRIPTION OF THE DRAWINGS

FIG. 1 illustrates a “top-to-bottom” configuration for a system for conditioning a space within a surrounding environment, according to exemplary embodiments of the present invention.

FIG. 2 illustrates a “top-to-bottom” configuration for a system for conditioning a space within a surrounding environment, according to exemplary embodiments of the present invention.

FIG. 3 illustrates a “bottom-to-top” configuration for a system for conditioning a space within a surrounding environment, according to exemplary embodiments of the present invention.

FIG. 4 illustrates a “bottom-to-top” configuration for a system for conditioning a space within a surrounding environment, with additional features of the present invention.

FIG. 5 illustrates another “top-to-bottom” configuration for a system for conditioning a space within a surrounding environment, according to exemplary embodiments of the present invention.

FIG. 6 illustrates a system for conditioning a space within a surrounding environment and some of the peripheral features that may be utilized to circulate conditioned air, according to exemplary embodiments of the present invention.

FIG. 7 illustrates a schematic of a “top-to-bottom” configuration for a system for conditioning a space within a surrounding environment, according to exemplary embodiments of the present invention.

FIG. 8 illustrates a schematic of a “top-to-bottom” configuration for a system for conditioning a relatively small space within a surrounding environment, according to exemplary embodiments of the present invention.

FIG. 9 illustrates a schematic of a “top-to-bottom” configuration for a system for conditioning a relatively large space within a surrounding environment, according to exemplary embodiments of the present invention.

FIG. 10 illustrates a schematic of a “top-to-bottom” configuration for a system for conditioning two separate spaces, for two occupants, within a surrounding environment, according to exemplary embodiments of the present invention.

FIG. 11 illustrates a schematic of a “top-to-bottom” configuration for a system for conditioning a space, for two occupants in the seated position, within a surrounding environment, according to exemplary embodiments of the present invention.

FIG. 12 illustrates a photograph of a “top-to-bottom” configuration of a system for conditioning a space, with single occupant in a prone position within the space, according to exemplary embodiments of the present invention.

FIG. 13 illustrates a photograph of a “top-to-bottom” configuration of a system for conditioning a space, with single occupant in a prone position within the space, according to exemplary embodiments of the present invention.

FIG. 14 summarizes experimental data collected for a baseline air conditioning system that conditioned the entire volume of a sleep compartment, and the resultant empirical metrics representing occupant comfort and sensation.

FIG. 15 illustrates experimental data collected for the “top-to-bottom” system illustrated in FIG. 12 and the resultant empirical metrics representing occupant comfort and sensation.

FIG. 16 compares the energy usage of the “top-to-bottom” system illustrated in FIG. 12 to that of a baseline configuration cooling the entire sleeper compartment, where each configuration targeted identical temperature setpoints of 72° F.

FIG. 17 compares the energy usage of the “top-to-bottom” system illustrated in FIG. 12 to that of a baseline configuration cooling the entire sleeper compartment, where each configuration targeted identical occupant comfort levels.

FIG. 18 illustrates an example of flow vectors and flow fields from http://www.deskeng.com/de/human-body-thermoregulation-model-integrated-with-sc-tetra-cfd-software/.

FIG. 19 illustrates one example of how slats may be oriented in a register to control the flowrate and direction of an exiting conditioned airflow, according to exemplary embodiments of the present invention.

### REFERENCE NUMBERS

| | |
|---|---|
| 100 | space |
| 101 | system |
| 110 | surrounding environment |
| 120, 121 | conditioned airflow |
| 122, 123 | conditioned airflow-first portion |
| 124, 125 | conditioned airflow-second portion |
| 126 | return airflow |
| 128, 129 | return airflow-first portion |
| 130, 131 | return airflow-second portion |
| 138, 139 | air boundary |
| 140 | solid boundary |
| 150, 151 | air supply aperture |
| 160 | air return aperture |
| 170 | second conditioned airflow |
| 500 | space |
| 501 | system |
| 510 | surrounding environment |
| 520, 521, 522, 523 | conditioned airflow |
| 525, 526, 527, 528 | return airflow |
| 550, 551, 552, 553 | air supply aperture |
| 560, 561, 562, 563 | air return aperture |
| 570 | air supply line |
| 572 | air supply manifold |
| 574 | air return manifold |
| 576 | air return line |
| 578 | air conditioning unit |
| 580 | air-mover |
| 582 | heat exchanger |
| 584 | heat transfer fluid supply line |
| 586 | heat transfer fluid return line |
| 590 | occupant |
| 600 | space |
| 601 | system |
| 610 | surrounding environment |
| 615, 616 | conditioned airflow |
| 617, 618 | return airflow |
| 620, 621 | combined airflow |
| 640, 641 | solid boundary |
| 650, 651, 652, 653 | air supply aperture |
| 660, 661, 662 | air return aperture |
| 672 | air supply manifold |
| 674, 675, 676 | air return manifold |
| 690 | occupant |
| 900 | space |
| 901 | system |
| 910 | surrounding environment |
| 920, 921 | air flow |
| 940 | solid boundary |
| 950, 951, 952, 953 | air supply aperture |
| 960, 961 | air return aperture |
| 972 | air supply manifold |
| 974, 975 | air return manifold |
| 990 | second occupant |

### DETAILED DESCRIPTION OF EXEMPLARY EMBODIMENTS

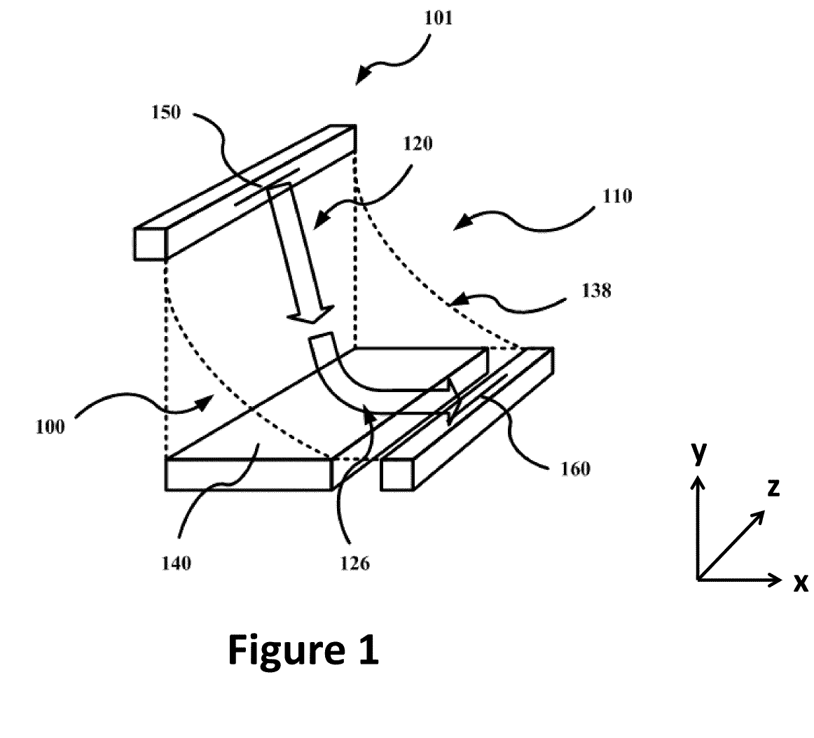

FIG. 1 illustrates a system 101 for conditioning a space 100 within a surrounding environment 110. In some embodiments of the present invention, the space 100 may be at least a portion of the sleeper compartment within the cab of a long-haul truck. Conditioning may include heating the space 100, cooling the space 100, humidifying the space 100, dehumidifying the space 100, and/or any other desirable treatment of the air occupying the space 100. For example, if the surrounding environment 110 is relatively hot and humid, the space 100 may be cooled and dehumidified. Or, if the surrounding environment 110 is relatively cold and dry, the space 100 may be heated and humidified. Therefore, the conditioning provided to the space 100 may depend upon the particular circumstances, conditions of the surrounding environment 110, and/or the environmental climate.

The system 101 includes at least one air supply aperture 150 configured to direct at least one conditioned airflow 120 towards at least one solid boundary 140. The conditioned airflow 120 may be heated, cooled, humidified, dehumidified, and/or conditioned in any other desirable manner. In addition, the system 101 includes at least one air return aperture 160 configured to receive at least one return airflow 126. Together, the conditioned airflow 120 and the return airflow 126 create at least one air boundary 138 positioned between the space 100 and the surrounding environment 110. In some embodiments, the conditioned airflow 120 and the return air flow 126 may form one substantially continuous airflow flowing from the air supply aperture 150 to the air return aperture 160. Thus, the solid boundary 140 and the air boundary 138 define the space 100 within the surrounding environment 110.

The air supply aperture 150 may be a single air aperture or a plurality of air apertures. For example, the air supply aperture 150 may be a single slot, as shown in FIG. 1. Alternatively, some embodiments of the present invention may include a plurality of air supply apertures such as a series of holes and/or vertical slots, where each air supply aperture supplies its own individual conditioned airflow. In these embodiments, the plurality of air supply apertures creates a plurality of conditioned airflows. The air supply aperture 150 may be in the form of at least one hole, slit, slot, nozzle, vent, and/or register. In addition, the air supply aperture 150 may include hardware (not shown) to assist with directing at least a portion of the conditioned airflow 120 towards a specific location in the space 100, towards the solid boundary 140, and/or towards and/or along the air boundary 138. For example, the air supply aperture 150 may include a register configured with a plurality of horizontal or vertical slats positioned across the open surface area of the register. The slats may be configured to move together or individually so that the conditioned airflow 120 may be directed towards a specific location in the space 100 and/or along a specific trajectory or path within the space 100 and/or bordering the space 100 and/or along any other desirable trajectory. In some embodiments of the present invention, the moveable slats of a register may include two or more collections of slats, where each collection may be moved in unison and independently of other collections of slats, so that the register may create two or more independently directed and conditioned airflows. A slat may be configured as an essentially two-dimensional, planar structure that may be rotated around one of its axes. Rotation of the slat may change the open surface area of its associated aperture, thus changing the velocity of the air exiting the aperture and/or the direction of the air exiting the aperture. Slats may aid in closing the register to block all or most of the air passing through the register. In some embodiments, one or more registers may be positioned at or near of a manifold, thereby defining a grill, where a lower surface of the grill may be flush against the surface and/or one or more registers may be positioned away from a surface of a manifold.

The air return aperture 160 may be a single air aperture configured to receive a return airflow 126. For example, the air return aperture 160 may be a single slot, as shown in FIG. 1. In some embodiments of the present invention, the air return aperture 160 may include a plurality of air return apertures such as a series of holes and/or vertical slots, where each air return aperture receives its own individual return airflow. In these embodiments, the plurality of air return apertures receives a plurality of return airflows. The air return aperture 160 may be in the form of at least one hole, slit, slot, nozzle, vent, and/or register. In addition, the air return aperture 160 may include hardware (not shown) to assist with receiving the return airflow 126 and to influence the direction of the return airflow 126 in three-dimensional space. The air return aperture 160 may be configured as a register, which may be adjusted so that the return airflow 126 originates substantially from inside the space 100 and/or substantially from the direction of the air boundary 138 and/or flows essentially parallel to the direction of flow of the conditioned airflow 120. For example, the air return aperture 160 may include a register supplied with a plurality of horizontal or vertical slats positioned across the open surface area of the register. The slats may be configured to move together or individually so that the return airflow 126 defines a desirable flow trajectory from the space 100 and/or along the air boundary 138 and/or any other desirable flow trajectory. In some embodiments of the present invention, the moveable slats of a register may include two or more collections of slats, where each collection may be moved in unison and independently of the other collections of slats, so that the register may create two or more independent return airflows, where each defines a different flow trajectory.

The solid boundary 140 may include any solid surface, such as a wall, a floor, and/or a ceiling. Alternatively, the solid boundary 140 may include a bed, a mattress, a blanket, a curtain, a door, a window, and/or any other desirable solid boundary. As shown in FIG. 1, most solid boundaries may include a thickness in the Y-axis direction. However, the solid boundary 140 as defined herein is the outer surface of a three-dimensional object (e.g. a bed) that borders and defines a boundary with the space 100. Thus, the solid boundary 140 may be a substantially flat planar boundary (e.g. as shown in FIG. 1), a substantially curved planar boundary, a substantially non-planar boundary that varies significantly in all three dimensions of three-dimensional space, or any other desirable shape.

In some embodiments of the present invention, an object (not shown) may be positioned on the solid boundary 140. The object may be a physical item stored within the space 100, or it may be a person residing within the space 100 (e.g. a driver or passenger).

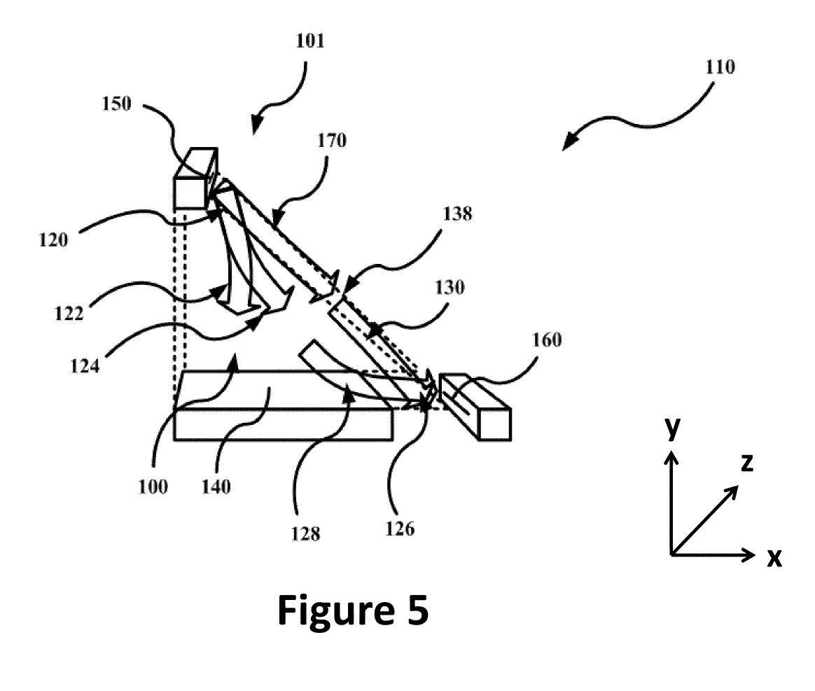

The air boundary 138 is created by the conditioned airflow 120 and the return airflow 126. In some embodiments, as shown in FIG. 1, the air boundary 138 may be a substantially curved planar boundary. In other embodiments, as shown in FIG. 5, the air boundary 138 may be a substantially flat planar boundary. Referring again to FIG. 1, the air boundary 138 and the solid boundary 140 provide a barrier that minimizes and reduces heat transfer and mass transfer from the surrounding environment 110 into the space 100 and/or from the space 100 into the surrounding environment 110. The solid boundary 140 provides a solid physical barrier. The air boundary 138 provides a moving barrier of flowing air. Together, these boundaries minimize the mixing of air between the surrounding environment 110 and the air filling the space 100. Thus, the conditioned airflow 120 supplies conditioned air predominantly to the space 100 to maintain the desired climate within the space 100. The conditioned airflow 120 supplies none or minimal conditioned air to the surrounding environment 110. Thus, the conditioned airflow 120 and return airflow 126 create at least one air boundary 138, which together with the at least one solid boundary 140, prevents or minimizes leakage of unconditioned air from the surrounding environment 110 into the space 100 and/or leakage of conditioned air from the space 100 to the surrounding environment 110.

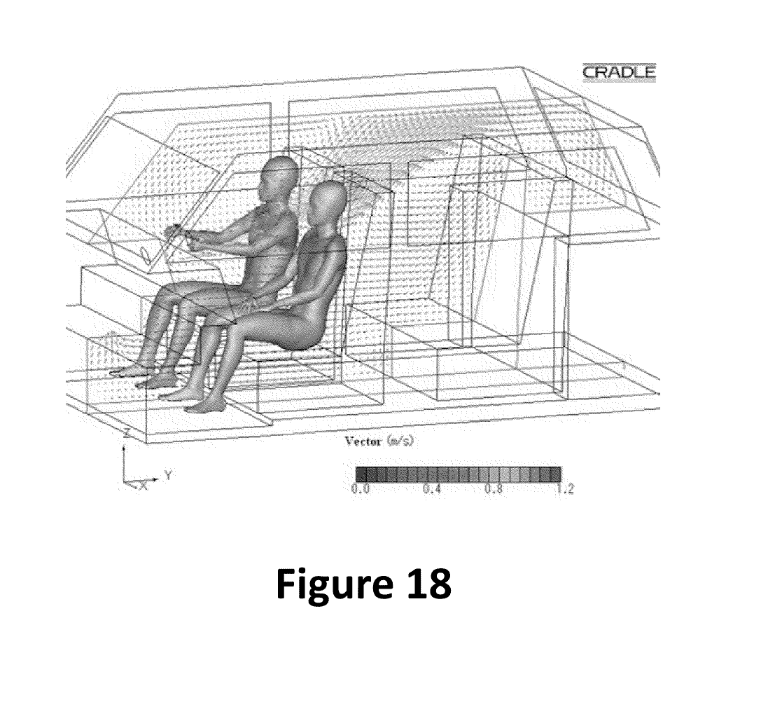

In some embodiments of the present invention, the conditioned airflow 120 may have a volumetric flow rate of air ranging from about 1 cubic foot per minute (CFM) as measured at actual conditions (e.g. temperature and pressure) to about 1000 CFM. The conditioned airflow 120 may also have a gas velocity, where the gas velocity may range from about 1 foot per second (ft/sec) to about 100 ft/sec. The conditioned airflow 120 may also have a flow vector (not shown) describing both a gas velocity and a direction. The conditioned airflow 120 may be described by a collection of flow vectors to form a vector field (not shown). In further embodiments, the flow vectors forming the conditioned airflow 120 may include flow vectors exiting the air supply aperture 150 in a direction substantially towards the solid boundary 140 and maintained substantially within planes parallel to the XY plane. FIG. 18 illustrates an example of flow vectors and vector fields for airflow from a vent, as predicted using computational fluid dynamics. (See http://www.deskeng.com/de/human-body-thermoregulation-model-integrated-with-sc-tetra-cfd-software/.)

In some embodiments of the present invention, the return airflow 126 may have a volumetric flow rate of air ranging from about 1 CFM to about 1000 CFM. The return airflow 126 may also have a gas velocity, where the gas velocity may range from about 1 ft/sec to about 100 ft/sec. The return airflow may also have a flow vector (not shown) describing both a gas velocity and a direction. The return airflow 126 may be described by a collection of flow vectors to form a vector field (not shown). In further embodiments, the flow vectors forming the return airflow 126 may include flow vectors entering the air return aperture 160 and originating substantially from within the space 100 and/or from the direction of the solid boundary 140. In addition, the flow vectors describing the return airflow 126 may be maintained substantially within planes parallel to the XZ plane.

The exemplary embodiment of FIG. 1 shows a conditioned airflow 120 originating from an air supply aperture 150 placed at a relatively high point on the Y-axis and a return airflow 126 terminating at an air return aperture 160 placed at a relatively low point on the Y-axis. Together, the conditioned airflow 120 and the return airflow 126 form a combined airflow that follows a path described herein as a “top-to-bottom” configuration. A “top-to-bottom” configuration may be preferred in some circumstances, such as when providing cooled air to the space 100 within a relatively warm surrounding environment 110. The relatively cool conditioned airflow 120 may have a higher gas density relative to the gas occupying the lower levels of the space 100 (in the Y-axis), which may facilitate better flow of conditioned air through the space 100 and to the air return aperture 160. However, the scope of the present invention also includes an alternative embodiment, a “bottom-to-top” configuration, where the air supply aperture 150 is placed at a relatively low point on the Y-axis, and the air return aperture 160 is placed at a relatively high point on the Y-axis. Thus, a “bottom-to-top” configuration may provide a conditioned airflow 120 originating at a relatively low point (on the Y-axis), and a return airflow 126 terminating at a relatively high point (on the Y-axis). As a result, in this example, the conditioned airflow 120 and the return airflow 126 form a combined airflow that follows a path describing a “bottom-to-top” trajectory. A “bottom-to-top” configuration may be desirable in circumstances where heated air is provided to the space 100 within a relatively cool surrounding environment 110. The relatively warm conditioned air 120 may have a lower gas density relative to the gas occupying the upper levels of the space 100 (in the Y-axis), which may facilitate better flow of conditioned air from the air supply aperture 150, through the space 100, and to the air return aperture 160.

In some embodiments of the present invention, the conditioned airflow 120 may be created by an air-mover (not shown) that produces an elevated pressure, relative to the air pressure in the space 100 and/or surrounding environment 110. Examples of air-movers include blowers, fans, pumps, and compressors. Thus, higher pressure air moving across the air supply aperture 150 into the lower pressure space 100 results in the conditioned airflow 120. In addition, the air-mover may also create the return airflow 126 by creating suction and lower-pressures downstream of the air return aperture 160. Accordingly, higher-pressure air in the space 100 may be drawn by the suction created by the air-mover, through the air return aperture 160, resulting in the formation of the return airflow 126.

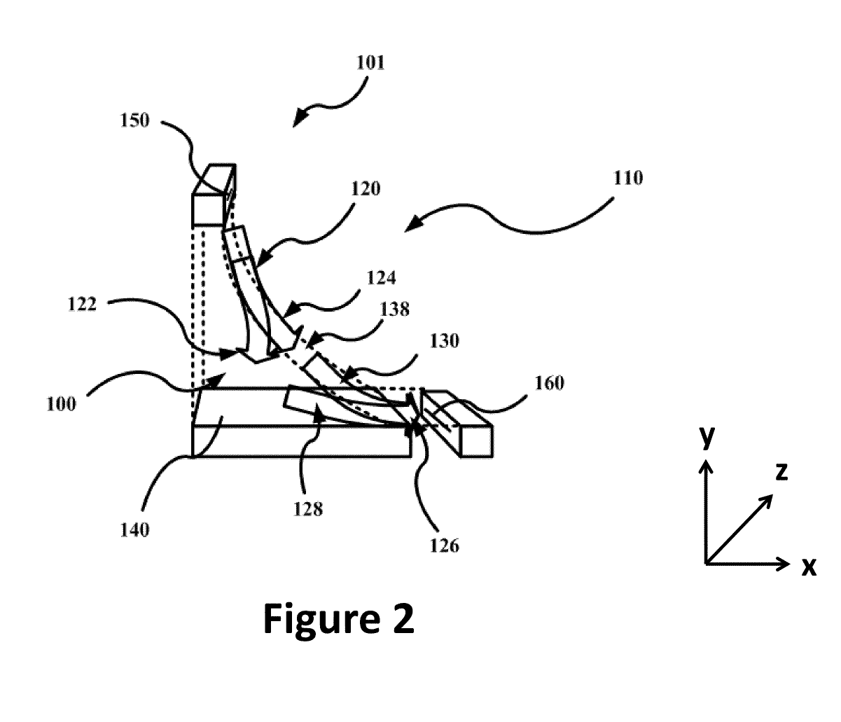

FIG. 2 illustrates a system 101 for conditioning a space 100 within a surrounding environment 110, the system 101 including at least one air supply aperture 150 configured to direct at least one conditioned airflow 120 towards at least one solid boundary 140. The conditioned airflow 120 may be heated, cooled, humidified, dehumidified, and/or conditioned in any other desirable manner. In addition, the system 101 includes at least one air return aperture 160 configured to receive at least one return airflow 126. Together, the conditioned airflow 120 and the return airflow 126 create at least one air boundary 138, which in turn, defines, together with the solid boundary 140, the space 100 within the environment 110.

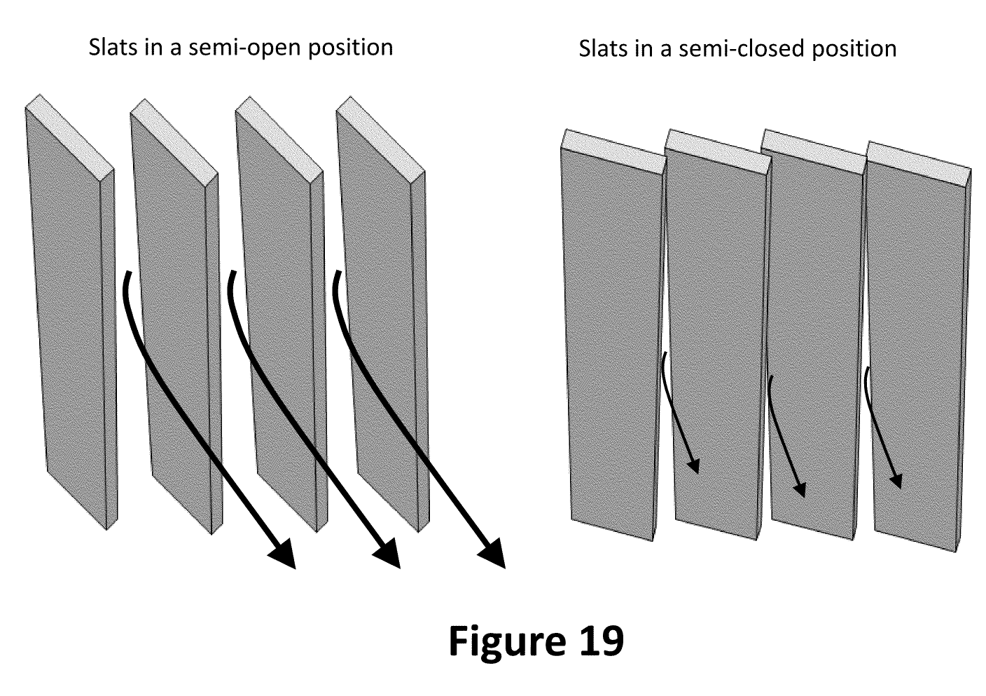

As shown in FIG. 2, the conditioned airflow 120 may include a first portion 122 that is directed substantially toward the solid boundary 140 and into the space 100. In addition, the conditioned airflow 120 may also include a second portion 124 that is substantially aligned with and/or parallel to and/or directed along the air boundary 138. The first portion 122 and the second portion 124 of the conditioned airflow 120 may be formed by at least one air supply aperture 150 configured as a register. The register may include at least two independent groups of slats, which may split or divide the conditioned airflow 120 into a first portion 122 and a second portion 124. The first portion 122 of the conditioned airflow 120 may predominantly supply conditioned air to the space 100, while the second portion 124 of the conditioned airflow 120 may predominantly form the air boundary 138 separating the space 100 from the surrounding environment 110. FIG. 19 illustrates an example where four identical slats or configured to move together as a group to control air flowrate and direction, for two different positions. In the first position, the slats are in a semi-open position such that they allow a relatively high flow rate to pass through the slats and where the airflow is directed towards the right-hand side of the page. In the second position, the slats are in a semi-closed position, where the passage of air past the slats is effectively blocked.

In some embodiments of the present invention, the first portion 122 of the conditioned airflow 120 may include about 1 volume % (vol %) of the conditioned airflow 120 to about 100 vol % of the conditioned airflow 120. The second portion 124 of the conditioned airflow 120 may include about 0 vol % of the conditioned airflow 120 to about 99 vol % of the conditioned airflow 120.

Referring again to FIG. 2, the return airflow 126 may include a first portion 128 originating substantially from within the space 100, and a second portion 130 originating substantially from the second portion 124 of the conditioned airflow 120 and/or originating from flow vectors substantially following and/or defining the air boundary 138. The first portion 128 and the second portion 130 of the return airflow 126 may be formed by at least one air return aperture 160, which may be configured as a register. The register may include at least two independent groups of slats, which may create a first portion 128 and a second portion 130, which eventually join together as the return airflow 126 in the vicinity of the air return aperture 160. In some embodiments of the present invention, the first portion 128 of the return airflow 126 may predominantly remove air from the space 100, while the second portion 130 of the return airflow 126 may predominantly form the air boundary 138 separating the space 100 from the surrounding environment 110. The first portion 128 of the return airflow 126 may include about 1 vol % of the return airflow 126 to about 100 vol % of the return airflow 126. The second portion 130 of the return airflow 126 may include about 0 vol % of the return airflow 126 to about 99 vol % of the return airflow 126.

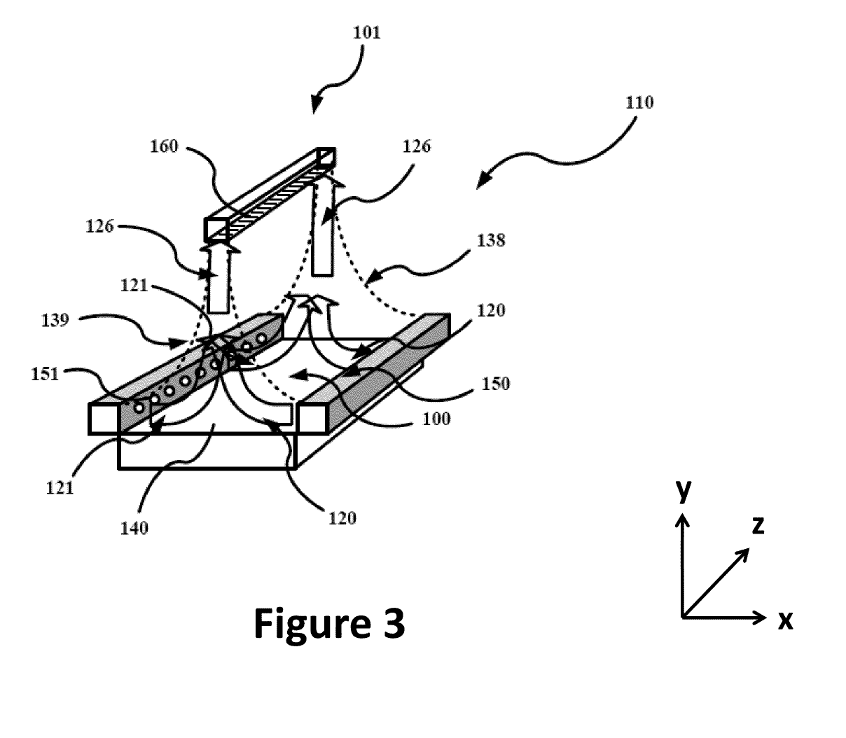

FIG. 3 illustrates another exemplary embodiment of the present invention, a system 101 for conditioning a space 100 within an environment 110. In this example, a “bottom-to-top” configuration is illustrated, that includes two distinct groups of air supply apertures, a first group air supply apertures 150 (not visible) and a second group of air supply apertures 151. The second group of air supply apertures 151 includes a plurality of circular holes aligned substantially horizontally in the XZ plane and along the Z-axis. It is to be understood that, for this example, the first group of air supply apertures 150 also includes a plurality of circular holes, also aligned substantially horizontally in the XZ plane and along the Z-axis and approximately facing the circular holes of the second group of supply apertures 151. Each circular hole for a given group of air supply apertures 150 and 151 provides its own conditioned airflow 120 and 121. So, the first group of air supply apertures 150 supplies a plurality of conditioned airflows 120, and the second group of air supply apertures 151 supplies a plurality of conditioned airflows 121. In this example, at least some of the conditioned airflows 120 and 121 are directed substantially parallel to the solid boundary 140 and into the space 100 being conditioned. The conditioned airflows 120 and 121 may impinge upon one another at the centerline (in the X-axis direction, not shown) of the solid boundary 140, which may force the conditioned air flows 120 and 121 in an upward direction in the XY plane, towards a group of air return apertures 160.

FIG. 3 also shows, for this exemplary “bottom-to-top” configuration, a plurality of return airflows 126 entering a plurality of air return apertures 160. In this example, the air return apertures 160 are represented as group of parallel horizontal slots. Together the plurality of conditioned airflows 120 and 121 and the plurality of return airflows 126 form at least two air boundaries 138 and 139 that separate the space 100 from the environment 110.

FIG. 3 also illustrates air supply apertures 150 and 151 that are slightly elevated along the Y-axis relative to the solid boundary 140. Thus, the relative position of either air supply apertures and/or air return apertures, relative to a solid boundary, may be adjusted according to a particular need or design requirement. In addition, the air supply apertures 150 and 151 in FIG. 3 are shown with an alignment substantially parallel with the XZ plane. Other embodiments of the present invention may rotate the orientation of any one or more of the air supply apertures and/or air return apertures around the Z-axis, in order to direct and/or receive one or more airflows in a desired direction.

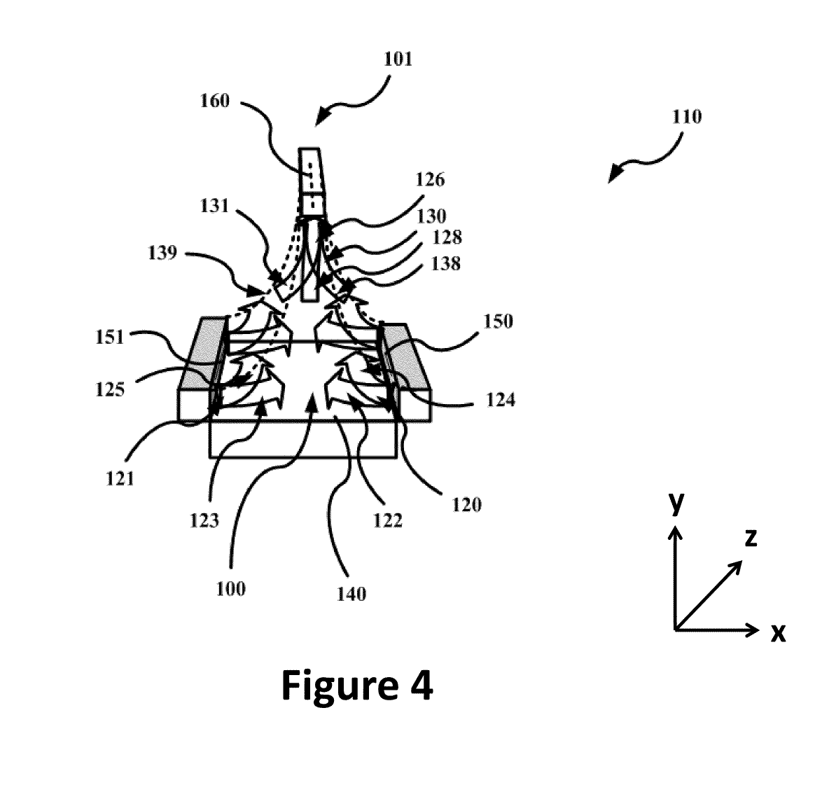

FIG. 4 shows a system 101 for conditioning a space 100 within an environment 110. The conditioned airflows 120 and 121 may each include first portions 122 and 123 respectively that may be directed substantially along the surface of the solid boundary 140 and into the space 100. In addition, the conditioned airflows 120 and 121 may also each include second portions 124 and 125 respectively that may be substantially aligned with and/or parallel to and/or directed along the air boundaries 138 and 139 respectively. The first portions 122 and 123 and the second portions 124 and 125 of the conditioned airflows 120 and 121 respectively may be formed by configuring air supply apertures 150 and 151 respectively as registers. Each air supply register may include at least two independent groups of slats, which may split or divide the conditioned airflows 120 and 121 into first portions 122 and 123 respectively and second portions 124 and 125 respectively. The first portions 122 and 123 of the conditioned airflows 120 and 121 respectively may predominantly supply conditioned air to the space 100, while the second portions 124 and 125 of the conditioned airflows 120 and 121 respectively may predominantly form the air boundaries 138 and 139 respectively separating the space 100 from the surrounding environment 110.

In some embodiments of the present invention, the first portions 122 and 123 of the conditioned airflows 120 and 121 respectively may include about 1 vol % of the conditioned airflows 120 and 121 respectively to about 100 vol % of the conditioned airflows 120 and 121 respectively. The second portions 124 and 125 of the conditioned airflows 120 and 121 respectively may include about 0 vol % of the conditioned airflows 120 and 121 respectively to about 99 vol % of the conditioned airflow 120 and 121 respectively.

Referring again to FIG. 4, the return airflow 126 may include a first portion 128 originating substantially from within the space 100, and two second portions 130 and 131, one on either side of the first portion 128 of the return airflow 126. Each of the second portions 130 and 131 of the return airflow 126 may originate substantially from the second portions 124 and 125 of the conditioned airflows 120 and 121 respectively and/or originate from flow vectors substantially following and/or defining the air boundaries 138 and 139 respectively. The first portion 128 and the second portions 130 and 131 of the return airflow 126 may be formed by at least one air return aperture 160 configured as a register. The register may include at least three independent groups of slats, which may create a first portion 128 and both second portions 130 and 131 of the return airflow 125, which merge together to form the return airflow 126 in the vicinity of the air return aperture 160. The first portion 128 of the return airflow 126 may predominantly remove air from the space 100, while the second portions 130 and 131 of the return airflow 126 may predominantly form the air boundaries 138 and 139 respectively separating the space 100 from the surrounding environment 110.

In some embodiments of the present invention, the first portion 128 of the return airflow 126 may include about 1 vol % of the return airflow 126 to about 100 vol % of the return airflow 126. The second portions 130 and 131 of the return airflow 126 may include about 0 vol % of the return airflow 126 to about 99 vol % of the return airflow 126.

In some embodiments of the present invention, multiple airflows originating at air supply apertures and/or terminating at air return apertures may be accomplished by configuring the apertures as registers, as described above. Thus, an individual aperture and/or group of apertures may be configured to provide or receive one or more airflows, where each individual airflow may have a unique flow rate, gas velocity, flow vector, and/or vector field. For example, a register may be configured to provide two airflows, where the first airflow may have a relatively high flow rate, a relatively high gas velocity, and a specific vector field, while the second airflow may have a relatively low flow rate, a relatively low gas velocity, and a substantially different vector field.

FIG. 5 illustrates such an example, in a “top-to-bottom” configuration for a system 101 for conditioning a space 100 within an environment 110. As in previously described embodiments, this example also includes at least one solid boundary 140 and at least one air boundary 138, which together define the space 100. This exemplary embodiment also includes at least one conditioned airflow 120. However, in this case, 100% of the conditioned airflow 120 is directed into the space 100. Further, the conditioned airflow 120 may also include at least one of a first portion 122 and a second portion 124 of the conditioned airflow 120. As described above, a register may create the first portion 122 and the second portion 124 of the conditioned airflow 120. Alternatively, the first portion 122 and the second portion 124 may be created by a physical barrier placed within the space 138 and/or by an air-mover (e.g. a fan or blower) placed within the space 100 to create turbulence, resulting in the formation of the two airflows. In this embodiment, approximately 100% of the conditioned airflow 120 provides conditioned air to the space 100, and essentially 0% of the conditioned airflow 120 is utilized to create the air boundary 138.

FIG. 5 also shows a second conditioned airflow 170 also originating from the air supply aperture 150. The purpose of the second conditioned airflow 170, in this example, is to create the air boundary layer 138. Therefore, the second conditioned airflow 170 provides little or no conditioned air to the space 100. Like the first portion 122 and the second portion 124 of the conditioned airflow 120, the second conditioned airflow 170 may be formed by an air supply aperture configured as a register (e.g. with sufficiently designed rotatable slats or groups of slats). The second conditioned airflow 170 may flow in a continuous, essentially uninterrupted path to the air return aperture 160, where it may merge with a return airflow 128 originating from within the space 100, to form the total return airflow 126 that is received and drawn into the air return aperture 160. Alternatively, as shown in FIG. 5, the second conditioned airflow 170 may also dissipate along the air boundary layer 138, and a new return airflow 130 may form due to the suction created by the air return aperture. This second portion 130 of the return airflow 126, may then merge with a first portion of the return airflow 126, originating from within the space, to form the final total return airflow 126. In some embodiments of the present invention, there may be no distinguishable transition from the second conditioned air flow 170 along the air boundary 138, and the second portion 130 of the return airflow 126.

Thus, FIG. 5 illustrates an exemplary embodiment where multiple airflows originate from one or more air supply apertures 150, where some of the flows (e.g. 120 dividing into 122 and 124) predominantly provide conditioned air to the space 100, while other airflows (e.g. 130 and 170) predominantly create air boundaries (e.g. 138). FIG. 5 also illustrates a case where a return airflow 126 is formed by the merging of one or more airflows (e.g. 128) originating from within the space 100 with one or more airflows (e.g. 130) forming the air boundary 138.

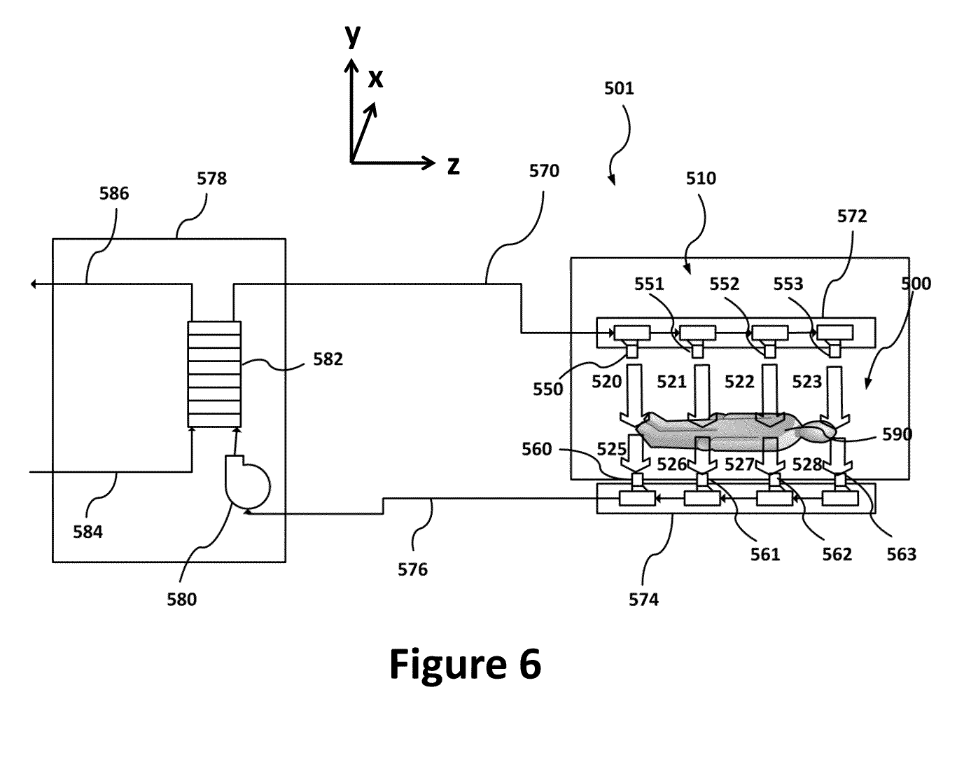

FIG. 6 shows another exemplary embodiment of the present invention, a “top-to-bottom” system 501 configured to supply conditioned air to a space 500, where the space is defined by at least one solid boundary (not shown) and at least one air boundary (not shown). The air boundary is created by a plurality of conditioned air flows 520-523 originating at a plurality of air supply apertures 550-553 positioned in and/or on an air supply manifold 572 (e.g. piping or ducting). The conditioned air may be supplied by an air-mover 580 (e.g. a blower or fan) that may form pressurized air at its discharge. The pressurized air may then move from a high-pressure zone at the discharge of the air-mover to a lower pressure zone within the space 500, resulting in the formation of the conditioned airflows 520-523 across the air supply apertures 550-553. The pressurized air may leave the air-mover 580 and may be channeled to the air supply manifold 572 by an air supply line 570 (e.g. piping and/or ducting).

The air boundary (not shown) is also at least partially formed by a plurality of return airflows 525-528, which are received by a plurality of air return apertures 560-563, which may be positioned within an air return manifold 574 (e.g. piping and/or ducting). The air return manifold 574 may be under relatively low pressure due to a suction produced by the air-mover 580. Thus, the suction may pull air into the return air manifold 574 through the air return apertures 560-563, resulting in the formation of the return airflows 525-528. The air pulled into the air return manifold 574 may then be channeled to the suction side of the air-mover 580 by an air return line 576 (e.g. appropriate piping and/or ducting).

FIG. 6 also illustrates an example of how the air circulating through the system 501 may be conditioned. The air-mover 580 may force air through a heat exchanger 582 where heat may be transferred between the air and a heat-transfer fluid, resulting in conditioned air, which may then be delivered to the space 500 as the conditioned airflows 520-523. For example, a heat transfer fluid may be supplied to the heat exchanger 582 by a heat transfer fluid supply line 584. The heat exchanger 582 may then transfer heat from the heat transfer fluid to the air, or alternatively, transfer heat from air to the heat transfer fluid. Then, the heat transfer fluid may exit the heat exchanger 582 via a heat transfer fluid return line 586. Heat may be transferred to the air by condensing a heat transfer fluid in the heat exchanger 582, and/or by the transfer of sensible heat from the heat transfer fluid to the air. Alternatively, heat may be transferred from the air to the heat transfer fluid by vaporizing a heat transfer fluid, and/or by the transferring sensible heat from the air to the transfer fluid.

FIG. 6 illustrates a heat exchanger where the fluids exchanging heat are in a parallel configuration. Counter-current configurations or any other desirable heat exchanger configuration may also be used. In addition, some embodiments of the present invention may include more than one heat exchanger and more than one heat transfer fluid and systems for delivering the heat transfer fluid(s). For example, a system for providing conditioned air to a space, may include a first heat exchanger and a first heat transfer fluid to provide cooling to the air, as well as a second heat exchanger and a second heat transfer fluid to provide heating to the air.

FIG. 6 also shows an occupant 590 (e.g. the driver or passenger of a long-haul truck) within at least a portion of the space 500. In this example, the occupant 590 may be in a prone position (as illustrated), or in a seated position, or in a standing position. Thus, the physical dimensions of the space 500 and the geometric relationships of the various elements relative to one another (e.g. air supply apertures 550-553 relative to the air return apertures 560-563 and relative to the solid boundary (not shown)) may depend on the intended use or uses of the space 500.

For example, a sleeper/living compartment, and a conditioned space therein (e.g. space 500 in FIG. 6) may be configured to accommodate an average adult male. As used herein, the height of an average American adult male is defined as about 5 feet (ft) 10 inches (in). Another relevant metric is the length from the waist to the crown of the head of an average American adult male. As used herein, this metric is defined as about 2 ft 11 in. In addition, the shoulder width of an average American adult male is defined herein as about 2 ft 6 in. These body dimensions of an average occupant may be used as general design guidelines for configuring the size and dimensions of a conditioned space.

Referring again to FIG. 3, a solid boundary 140 may be configured as a mattress to accommodate a sleeping adult male, in the prone position, with body dimensions as defined herein. In some embodiments, a length for the solid boundary 140 (in the Z-axis direction) may be defined by multiplying the average height value by a multiplier (e.g. 1.1) or by adding a length modifier (e.g. 1 ft). Thus, the first example using a multiplier, multiplying 5 ft 10 in by 1.1, results in a solid boundary layer 140 length of about 6 ft 5 in. The second example, adding a length modifier of 1 ft to 5 ft 10 in, results in a solid boundary 140 length of about 6 ft 10 in. Similar calculations may be performed to define the width of the solid boundary 140 (in the X-axis direction). In some embodiments, a width for the solid boundary 140 may be calculated by multiplying the average shoulder width metric of 2 ft 6 in by a factor of 1.1 to yield a target width for the solid boundary 140 of about 2 ft 9 in. Alternatively, a width for the solid boundary 140 may be calculated by adding a 1 ft length modifier to the average shoulder width metric of 2 ft 6 in to yield a target width for the solid boundary 140 of about 3 ft 6 in.

Similar calculations may be used to define the physical relationship and relative position of any other elements of the system. For example, consider the position of the air return apertures 160 (and/or manifold) relative to the solid boundary 140 and/or the air supply apertures (and/or manifold). In the example shown in FIG. 3, air return apertures 160 are positioned substantially along the solid boundary's 140 long-axis centerline (in the Z-axis direction). This orientation may facilitate more symmetrical conditioned airflows 120 and 121 and/or provide the desired shapes for the air boundaries 138 and 139. However, the height (in the Y-axis direction) of the air return apertures 160 (and/or manifold) relative to the solid boundary 140 is also required to more completely define the shape and volume of the space 100. In some embodiments, it may be desirable to define a space 100 with a height sufficient to accommodate an average adult male in a seated position, with legs outstretched on the solid boundary 140. This may also be calculated using either a multiplication factor or a length modifier, by adjusting the average waist-to-crown-of-head metric accordingly. For the multiplication factor case, one obtains 1.1×2 ft 11 in, which results in a height value (in the Y-axis direction) of about 3 ft 2 in. For the length adder case, one obtains 2 ft 11 in+1 ft, which results in a height value of about 3 ft 11 in.

Therefore, some embodiments of the present invention, may utilize a multiplication factor as described above for estimating a length dimension that defines a conditioned air space. In some cases, such a multiplication factor may range from about 0.5 to about 3. In some cases, a multiplication factor may range from about 0.9 to about 1.5. A length modifier may be used as described above for estimating a length dimension that defines the conditioned air space. In some cases, a length modifier may be used that ranges from about −3 ft to about +3 ft. In some cases, a length modifier may range from about −0.5 ft to about +2 ft.

The length dimensions of a conditioned space may be defined according to the average dimensions of the sleeper compartment of a long-haul truck. These dimensions are defined herein as including a depth (in the X-axis direction) of about 3 ft, a height of about 3 ft (in the Y-axis direction) and a length of about 6.5 ft. These dimensions result in a sleeper compartment volume of about 58.5 cubic feet. Thus, the linear dimensions defining the size and shape of the space being conditioned may also be defined utilizing these sleeper compartment dimensions as a basis; e.g. using a multiplication factor and/or a length modifier. Thus, the conditioned space within the sleeping compartment of a long-haul truck's cab (e.g. space 100 in FIG. 1) may have a volume ranging from about 20 cubic feet to about 50 cubic feet.

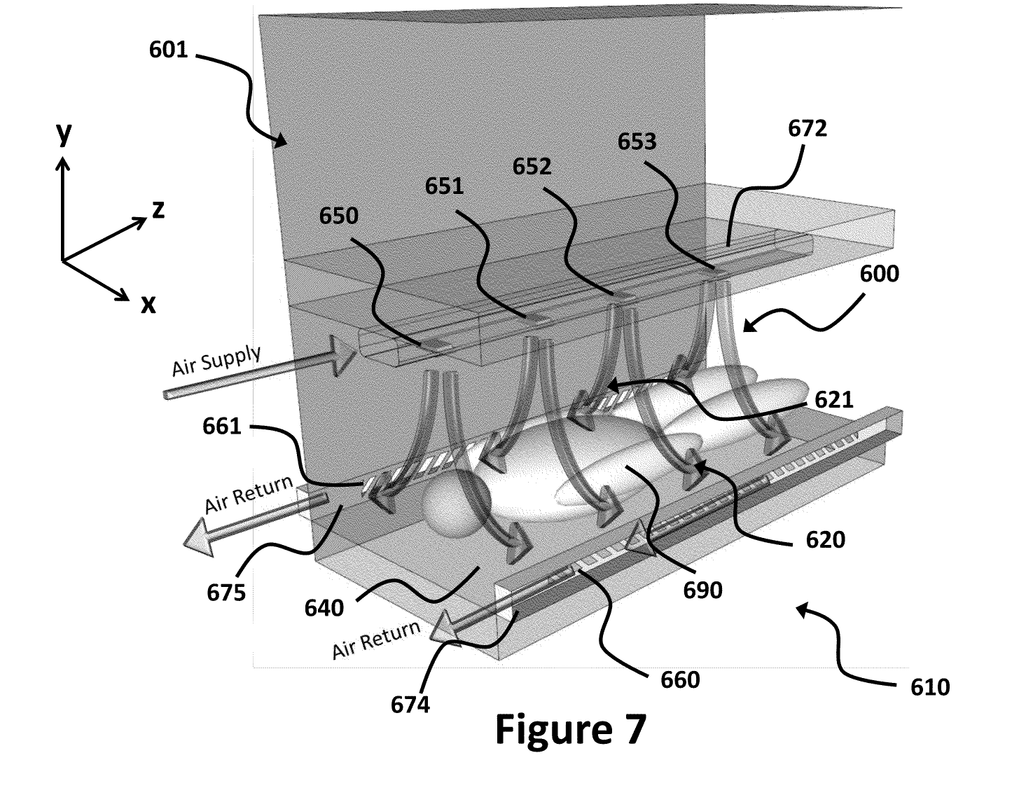

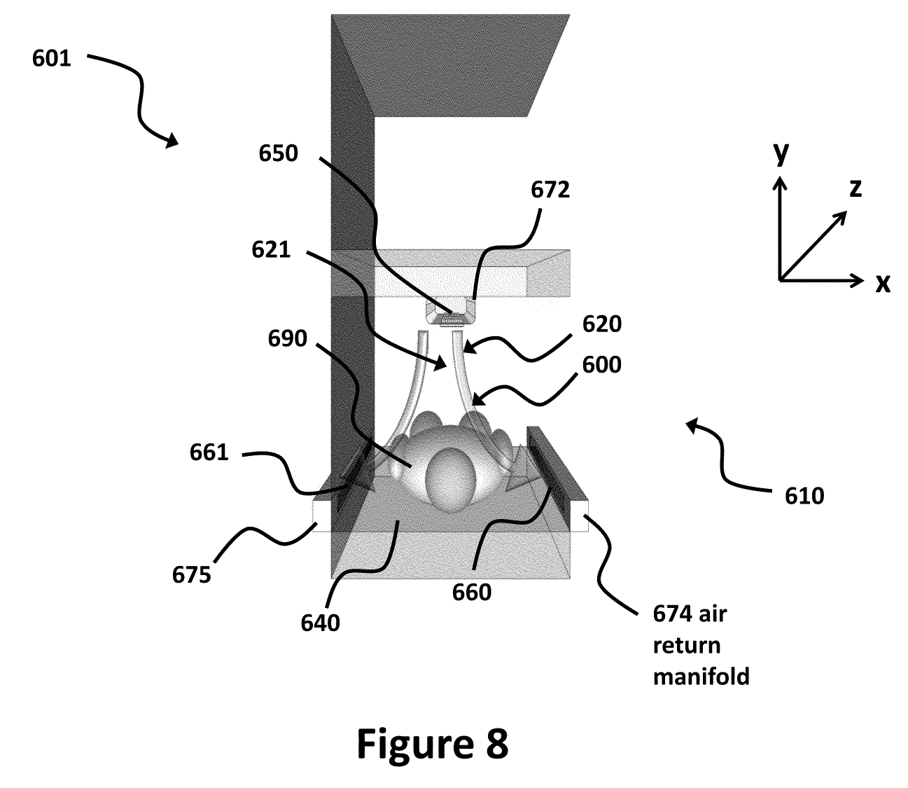

FIGS. 7-9 illustrate additional features of some embodiments of the present invention. For example, FIG. 7 illustrates a “top-to-bottom” system 601 where a single air supply manifold 672 is configured with a plurality of air supply apertures 650-653 that provide a plurality of conditioned airflows (not shown) to the space 600 containing an occupant 690. In this example, the air supply apertures 650-653 are configured as registers. The occupant 690 is lying in the prone position on a solid boundary 640. In addition, the system 601 contains two air return manifolds 674 and 675 configured with a plurality of air return apertures 660 and 661, which receive a plurality of return airflows (not shown). The air return apertures 660 may be configured as diagonal and parallel slots. Together, the conditioned airflows and the return airflows form a plurality of combined airflows 621, which create at least two air boundaries (not shown). Together, the at least two air boundaries and the solid boundary 640 create the space 600 within the surrounding environment 610. FIG. 8 provides a side perspective view of the embodiment illustrated in FIG. 7.

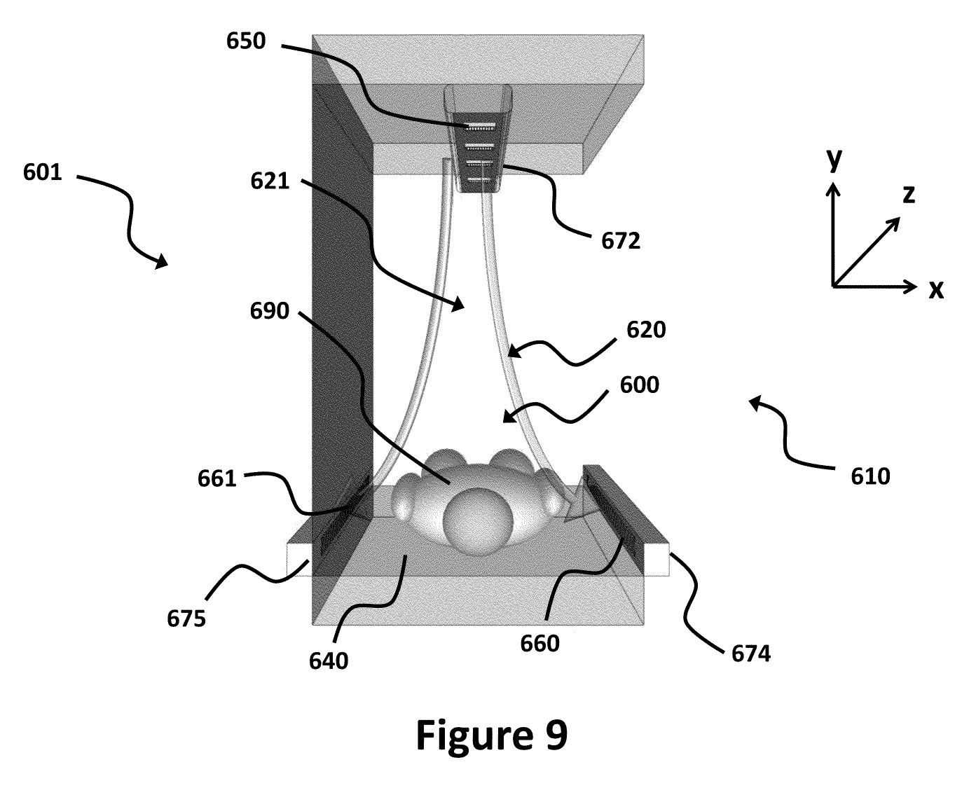

FIG. 9 is similar to FIG. 8 but further illustrates that the distance between the air supply manifold 672 and solid boundary 640 may be adjusted. In FIG. 8, this distance (or height in the Y-axis direction) is relatively short compared to the corresponding distance in FIG. 9. Thus, the embodiment of FIG. 9 provides a larger space 600 relative to the corresponding space 600 in FIG. 8. The distance between an air supply manifold 672 (or an air return manifold) and a solid boundary 640 may be adjusted by the occupant 690. By adjusting the height defining the space 600, the occupant may not only change the volume of the space 600, but may also change characteristics of the combined air flow 621; e.g. velocities, trajectories, etc.

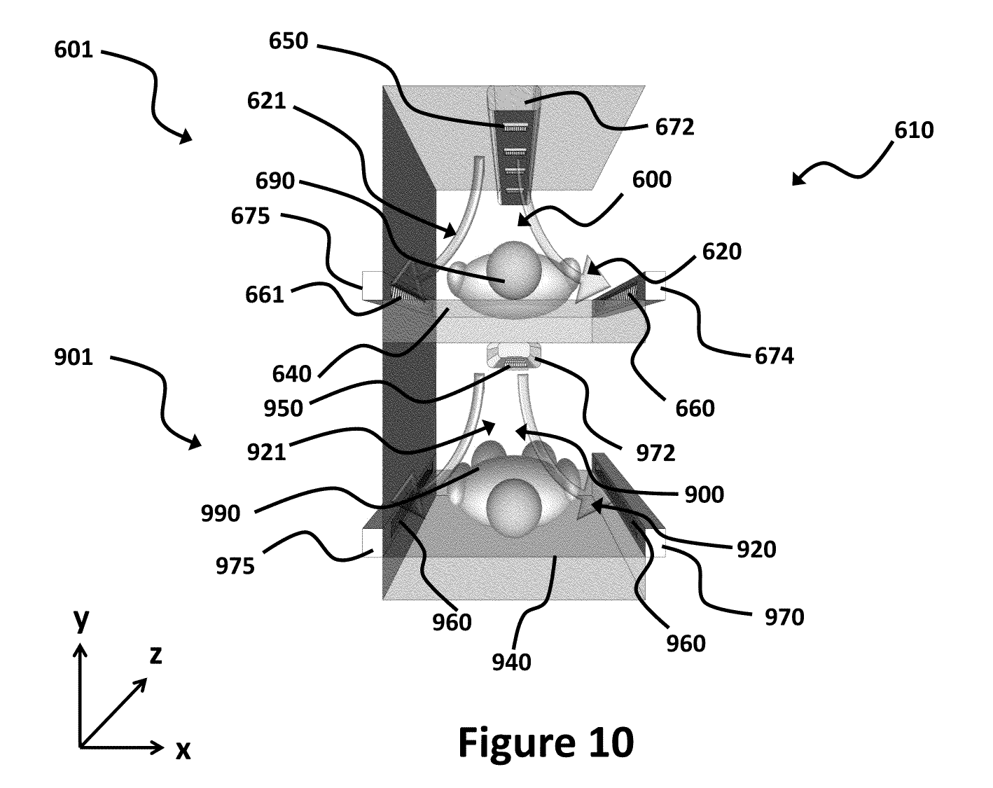

FIG. 10 illustrates another embodiment of the present invention, in which a sleeper compartment has been modified to provide two separate systems 601 and 901, each for conditioning a space 600 and 900 respectively, for two separate occupants 690 and 990 respectively. In this example, the two systems 601 and 901 are stacked on top of each other, like bunk beds. Other embodiments could include two or more systems stacked on one another. Each system 601 and 901 are otherwise essentially identical to the embodiments illustrated in FIGS. 7-9 and the details will not be repeated here.

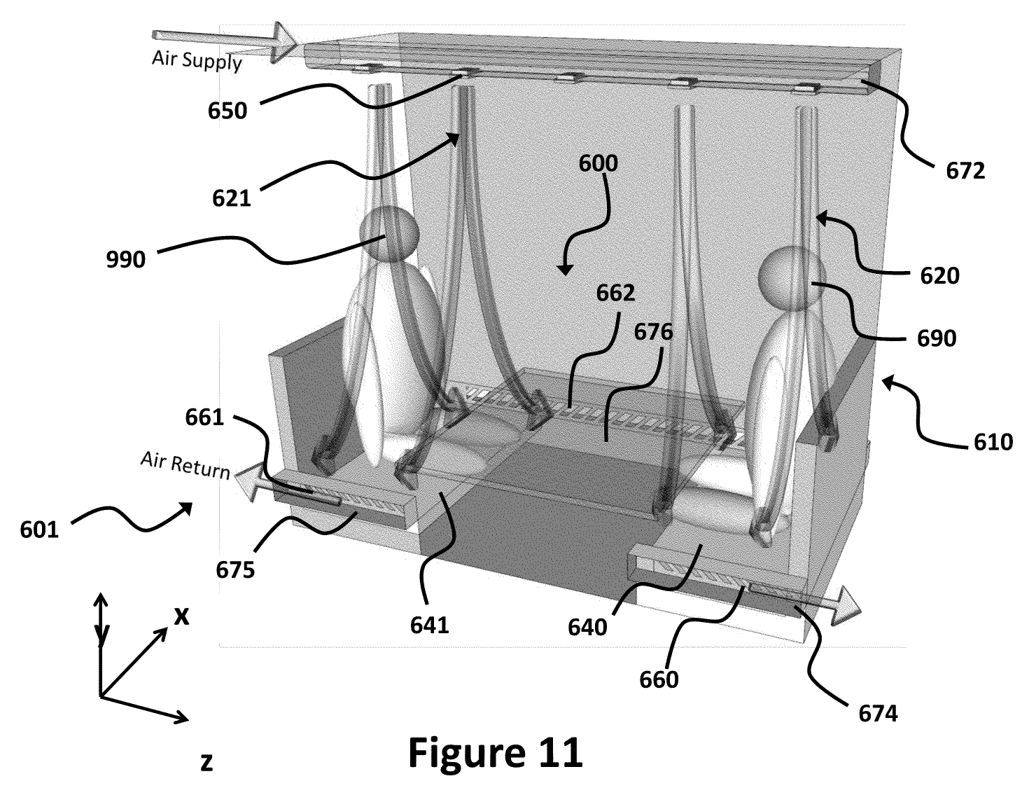

FIG. 11 shows another embodiment of the present invention, a system 601 for providing a conditioned space 600 within a surrounding environment 610 for two occupants 690 and 990 seated within the conditioned space 600, on solid boundaries (e.g. benches or seats) 640 and 641. FIG. 11 also illustrates a “top-to-bottom” configuration where conditioned air is directed to an air supply manifold 672 configured with a plurality of air supply apertures 650 that provide a plurality of conditioned airflows (not shown) to the space 600. Return airflows (not shown) are received by a plurality of air return apertures 660, 661, and 662 configured in air manifolds 674, 675, and 676. Together, the conditioned airflows and the return airflows form a plurality of combined airflows 621, which in turn create at least one air boundary (not shown).

Some of the embodiments described herein may provide climate control strategies that reduce energy use during periods of idling of long-haul trucks and/or climate control systems that are smaller, lighter, and/or more cost effective than related art solutions. In some cases, an onboard motor (other than the engine) may be used to power an auxiliary air conditioning device. For example, where the auxiliary conditioner is an electric air conditioner, the auxiliary air conditioning system may run on auxiliary power, which can be supplied by an onboard AC or DC generator. In some cases, an onboard generator may be a diesel powered generator. In some cases, the bank of batteries may be connected to an inverter, which can convert DC battery output into AC power to run an auxiliary conditioning unit. An auxiliary conditioner may also be powered by a domestic, off-board, electrical source (i.e. a “shore-power hookup”). In some cases, batteries may be recharged by the truck's alternator when the engine is running, by an onboard generator, and/or by an off-board source.

Some of the disclosed systems and methods may further reduce the idling time of a long-haul truck, thus reducing the amount of fuel used by an idling engine. These reductions may result in size reductions of auxiliary batteries utilized to power the system. Reductions in battery sizes may result in reduced system costs, weight reductions, and space savings. Some embodiments of the present invention may improve the efficiency of humidity control of a truck's cab environment. Some embodiments may also improve the circulation of fresh air through the sleeper compartment of a cab, which may in turn assist with maintaining appropriate CO₂ concentrations within the sleeper compartment and/or the control of odor.

The effectiveness of a climate conditioning system of a long-haul truck may be improved by limiting the mixing and/or entrainment of air from a surrounding environment into the space being conditioned. In some embodiments, the space being conditioned may be a subzone of the sleeper/cab compartment of a long-haul truck. It is noted, however, that the present disclosure is not intended to be limited to use in long-haul trucks. To the contrary, the disclosed methods and systems may be used to create conditioned spaces in other environments such as in trains, planes, ships, and/or any other suitable transportation vehicle. The methods and systems described herein may also be used in buildings and/or rooms of building; e.g. in cabins, hotel rooms, waiting areas, etc. In some embodiments, the generation of one or more conditioned spaces may be achieved without the need for establishing physical barriers between the occupant and the surrounding environment. This may be particularly advantageous by maintaining a larger percentage of open space within the local environment (e.g. with a truck's cab), thereby preventing an occupant of the conditioned space from feeling overly confined.

In some embodiments the manifolds and air supply and return lines may be in fluid communication with a conditioning system. A conditioning system may include one or more conditioning units such as a cooling unit and/or a heating unit. The conditioning units may typically include an inlet and an outlet. An inlet may be proximal to a return duct and an outlet may be proximal to a supply duct. Return air may be pulled from the conditioned space and an may enter the conditioning system at the air return apertures and travel through the return duct to the conditioning unit inlet. The return air may be conditioned (cooled or heated) by the conditioning unit and may then travel out of the conditioning unit at the outlet. The conditioned air may then enter the supply duct and exit the conditioning system and enter the conditioned space via the conditioned air supply apertures. One or more blowers or fans may be positioned in the conditioning system to aid in moving the air through the system.

In cases where air is cooled by a conditioning unit, an air conditioner may be used to extract heat from the return air. The air conditioner may also remove moisture from the return air. In cases where air is heated by a conditioning unit, a heater core may be used to warm the return air. The heater core may use heated coils or fins to heat the air. In some embodiments, a conditioning system may include both a cooling unit and a heating unit. In some cases, multiple conditioning units may be in series or in parallel.

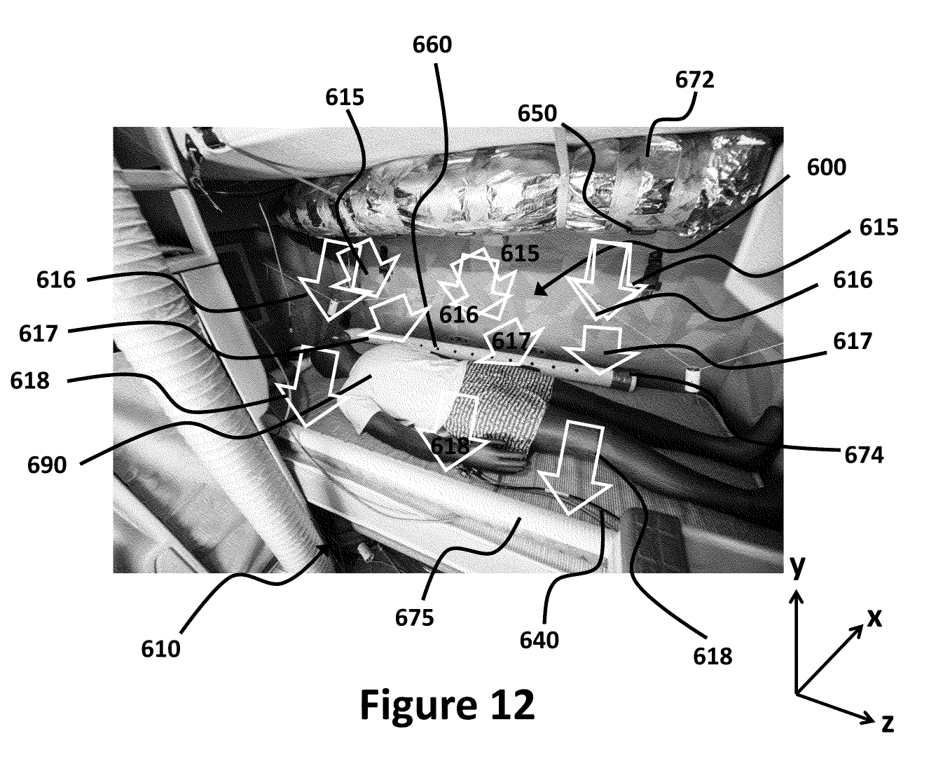

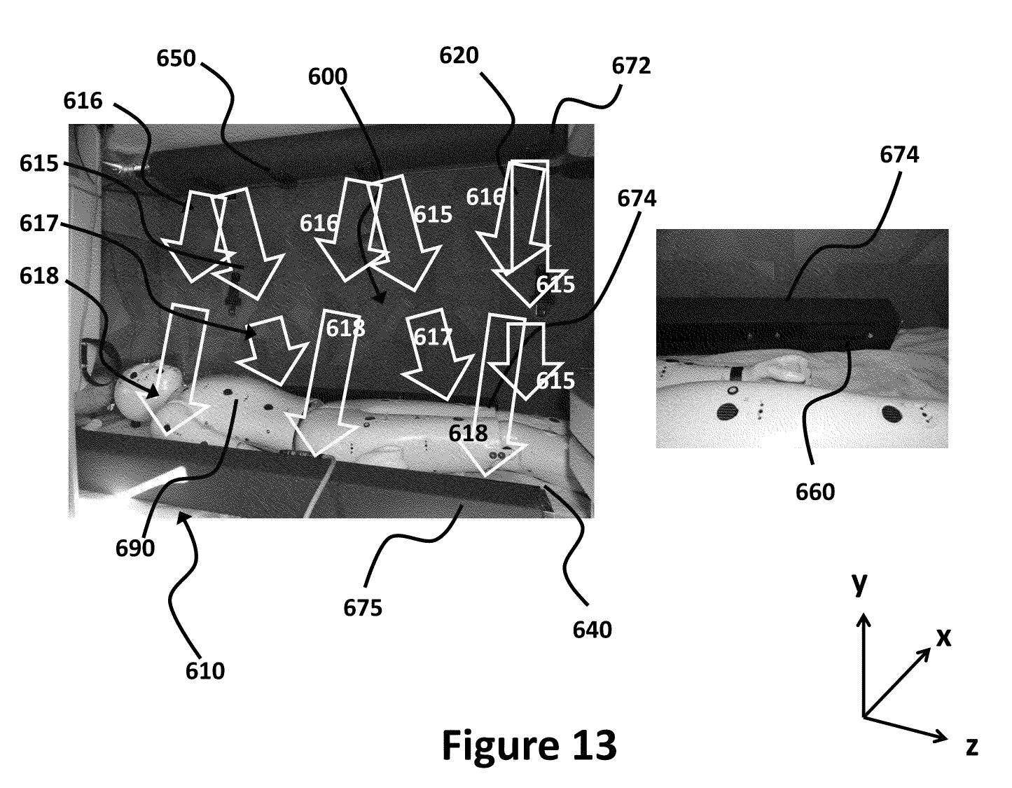

Experimental analysis has been performed for conditioning a space within a surrounding environment, using actual “bottom-to-top” configurations as illustrated in FIGS. 12 and 13. Specifically these figures illustrate a bunk bed configuration similar to that shown in FIG. 10. However, in this example, only the lower bunk is configured to provide a conditioned space for an occupant, much like the configuration summarized in FIG. 7. The prototypes illustrated in FIGS. 12 and 13 both provide a space 600 within a surrounding environment 610 (e.g. the rest of the cab). The space is defined by four solid boundaries configured as a bed 640, a back wall, and two sidewalls. A single air supply manifold 672 is configured with a plurality of air supply apertures 650, which provides a plurality of conditioned airflows 615 and 616. The conditioned space 600 is also configured with two air return manifolds 674 and 675, each configured with a plurality of air return apertures 660, with each air return aperture receiving a return airflow 617, 618. Together the conditioned air flows 615, 616 and the return airflows 617, 618 create two air boundaries (not shown). The air boundaries and the solid boundaries define the conditioned air space 600. A mannequin representing a human occupant 690 is positioned in the conditioned space 600.

This configuration is compared to a baseline-cooling configuration. The baseline configuration conditions the entire sleeping/living compartment (e.g. the space 600 and the surrounding environment 610), versus just the space 600 (e.g. the lower bunk). For these experiments, an auxiliary air-conditioning system is used in both the baseline and microenvironment configurations. The evaporator for the auxiliary system is located inside the sleeper compartment of a long-haul truck.

The desired conditioned airflows, their associated flow rates, and their directions are controlled by adjusting individual registers for each of the air supply apertures 650 distributed along the length of the air supply manifold 672. In the prototypes shown in FIGS. 12 and 13, two air return manifolds 674 and 675 are positioned next to the occupant 690 along the long axis of the bed and the occupant (e.g. along the Z-axis), with one air return manifold 674 and 675 on either side of the occupant 690. The air return manifolds 674 and 675 are under vacuum and thus draw air from the conditioned space 600, through the air return apertures 660, and into the air return manifolds 674 and 675, thus creating the return airflows 617 and 618, and achieving the desired flow patterns of conditioned air through the conditioned space 600.

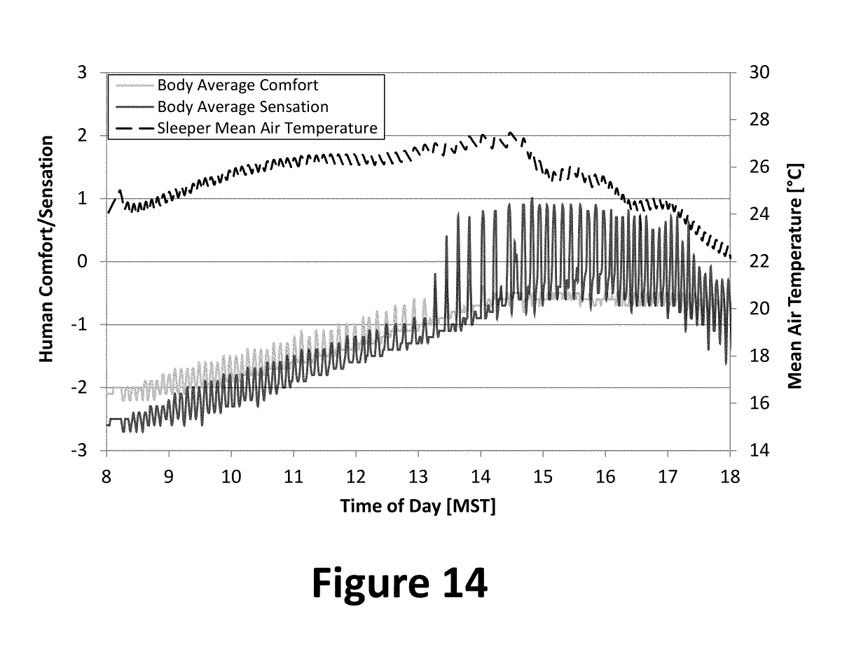

The mannequin used in these prototype tests is a thermal testing mannequin equipped with sensors and other devices to monitor the local environment immediately around the mannequin to allow data to be collected, which are then used to calculate empirical metrics representing comfort level within the conditioned space 600. (The mannequin used on these experiments is a Manikin®, manufactured by Measurement Technology Northwest.) The thermal mannequin body shown in FIG. 12 is constructed from carbon fiber and is shaped to match a typical shape of an average Western male. The body is segmented into 26 separate zones for data acquisition and control. The mannequin is equipped with an emulated thermoregulatory system with controllable metabolic rate, independent zonal control, sweating skin system, and real-time output of comfort and sensation metrics. For the testing, the mannequin metabolic rate is set at 0.7 mets to represent an occupant in a resting state. To establish the baseline configuration and obtain baseline data, the air conditioning system is set to maintain the entire volume of the sleeper compartment airspace at 72° F. FIG. 14 summarizes the data collected for this baseline configuration and shows metrics representing an overall comfort level and sensation level when conditioning the entire sleeper compartment. FIG. 14 also shows the average mean air temperature of the sleeper compartment during the test interval. The approximate volume of the sleeper compartment is approximately 6.5 m³.

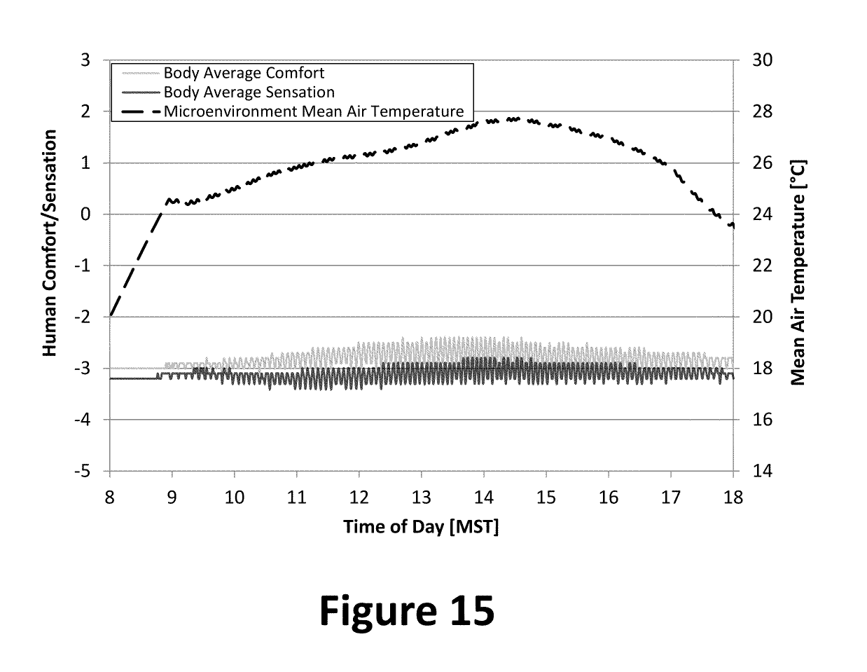

For comparison, when the conditioned space 600 was tested using the prototype system illustrated in FIG. 12. Once again, the air temperature was maintained at a temperature of 72° F. The geometric configuration and defining lengths of the space 600 (e.g. lengths, widths, and heights) reduces the volume of space being conditioned to approximately 1.66 m³. The results from the test where the entire space 600 is conditioned instead of the entire sleeper compartment are summarized in FIG. 15. FIG. 15 shows the data representing an overall comfort level and sensation level when conditioning just the conditioned space 600, instead of the entire sleeper compartment. FIG. 15 shows that providing conditioned air to only the conditioned space 600, using the system configuration illustrated in FIG. 12, is much more effective at maintaining a comfortable environment for the occupant 690 than conditioning the entire sleeper compartment.

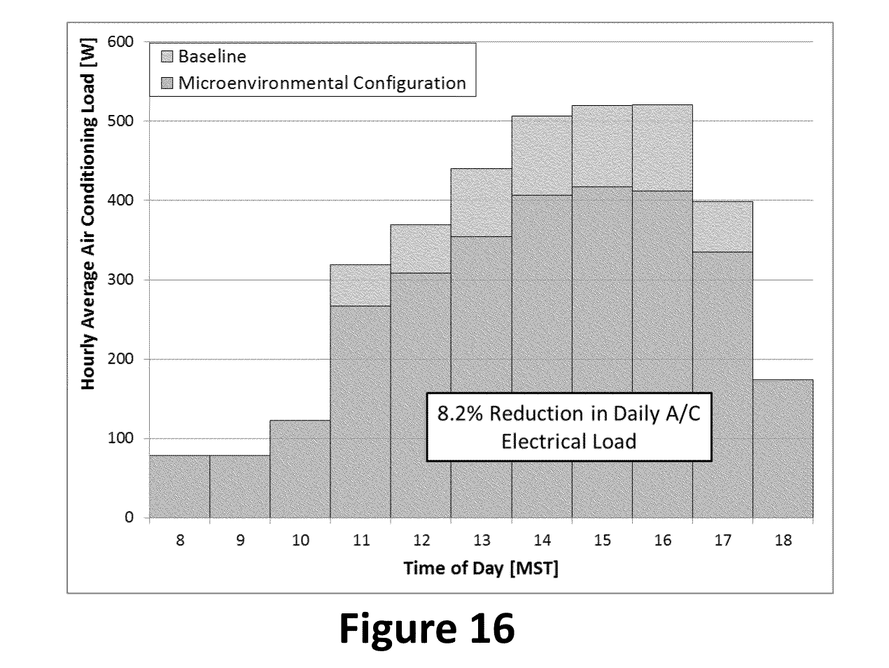

FIG. 16 shows a comparison of energy used by the two configurations; the baseline configuration (the entire sleeper compartment) and the configuration illustrated in FIG. 12 (just the conditioned space 600). Specifically, FIG. 16 shows an hourly average air conditioning energy use for both the baseline configuration and the “top-to-bottom” configuration of FIG. 12, with a temperature set-point of about 72° F. FIG. 15 shows that during the hottest parts of the day, from about 11 am through about 5 pm, the “top-to-bottom” configuration for the conditioned space 600 results in significantly reduced in power use, with a peak reduction at 3 pm of about 20%. Overall, the “top-to-bottom” cooling configuration of FIG. 12 demonstrates about an 8.2% reduction in daily A/C electrical load. These results are also tabulated below in Table 1. The reduction was calculated using the Baseline and Microenvironmental values in Table 1, as follows: % Reduction=100*(E_{baseline}−E_{“top-to-bottom”})/E_{baseline} where E_{baseline} and E_{“top-to-bottom”} are the cumulative daily baseline and “top-to-bottom” configuration energy used, respectively.

TABLE 1

| Time of Day | Microenvironmental (W) | Baseline Load (W) |
|---|---|---|
| 8 | 78.8 | 78.0 |
| 9 | 78.9 | 70.7 |
| 10 | 122.7 | 73.4 |
| 11 | 266.9 | 319.2 |
| 12 | 308.7 | 369.7 |
| 13 | 354.4 | 440.0 |
| 14 | 406.3 | 506.3 |
| 15 | 417.4 | 520.1 |
| 16 | 411.5 | 520.7 |
| 17 | 335.2 | 398.8 |
| 18 | 174.1 | 153.2 |

In these tests, as shown in FIG. 15, the “top-to-bottom” configuration actually serves to significantly overcool the mannequin compared to the baseline configuration. That is, the comfort and sensation metrics registered by the mannequin (−3) are significantly lower in this configuration when compared to those registered by the mannequin in the baseline configuration (which varied from −3 to about +1). The mannequin comfort and sensation scales are both 9 point scales that are centered around zero (−4 to 4; Arens, E., H. et al., Partial- and Whole-body Thermal Sensation and Comfort, Part I: Uniform Environmental Conditions. Journal of Thermal Biology, 31, 53-59 [2006]). For comfort values, the numbers correlate to the following: −4=Very Cold; −3=Cold; −2=Cool; −1=Slightly Cool; 0=Neutral; +1=Slightly Warm; +2=Warm; +3=Hot; +4=Very hot. For sensation values, there is not a term for each number, however, the scale is as follows: −4=Very Uncomfortable; −1=Just Uncomfortable; +1=Just Comfortable; +4=Very Comfortable.

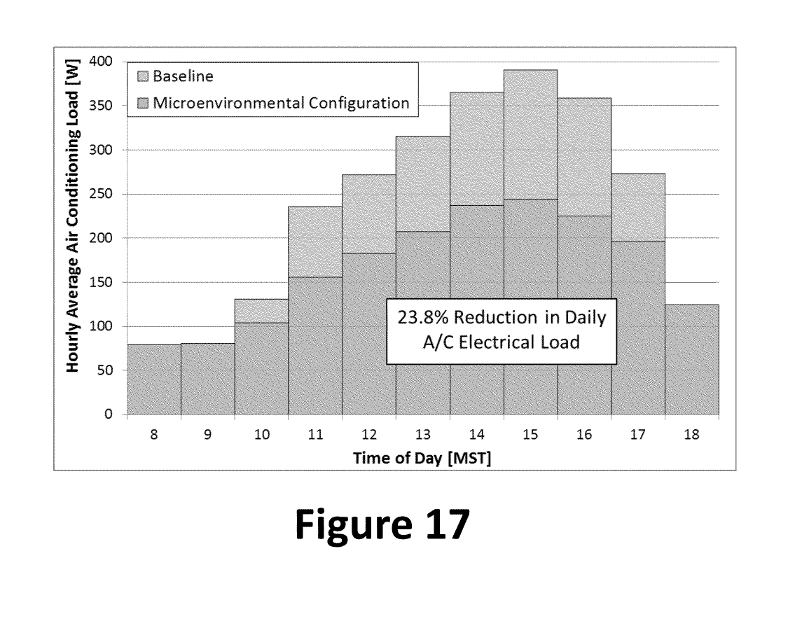

In order to equalize the comfort readings of the mannequin, both the baseline configuration test and the “top-to-bottom” configuration test are repeated. The air temperature setpoint of the baseline (cooling the entire sleeper compartment) is left unchanged at about 72° F. However, in order to achieve similar human comfort and sensation metrics and profiles for both the “top-to-bottom” configuration and the baseline configuration, the “top-to-bottom” configuration air temperature temperature setpoint is raised to 76° F. FIG. 17 compares the hourly average air conditioning energy use for both the baseline configuration maintained at about 72° F. and the “top-to-bottom” configuration of FIG. 12, maintained the slightly elevated temperature of about 76° F. Thus, FIG. 17 demonstrates an overall reduction in daily A/C electrical load of about 23.8%, with the greatest saving in energy occurring at about 3 pm (nearly 40% reduction).

The results from these experiments, completed on the prototype examples representing some embodiments of the present invention (e.g. FIGS. 12 and 13), suggest that conditioning a space (e.g. a portion of a sleeper compartment) within a surrounding environment (e.g. the rest of the sleeper compartment and/or the rest of a truck's cab) is capable of providing at least a 25% reduction in air condition energy use while providing a similar comfort level for an occupant. Significant energy savings should also be possible when the conditioned air is heated air.

It is noted that there are alternative ways of implementing the embodiments disclosed herein. While a number of exemplary aspects and embodiments have been discussed above, those of skill in the art will recognize certain modifications, permutations, additions and sub combinations thereof. Accordingly, the present embodiments are to be considered as illustrative and not restrictive. Furthermore, the claims are not to be limited to the details given herein, and are entitled their full scope and equivalents thereof.

What is claimed is:

1. A system for conditioning a space within an environment, the system comprising:
a solid boundary;
at least one air supply aperture configured to direct a conditioned airflow towards the solid boundary; and
at least one air return aperture configured to receive a return airflow, wherein:
at least one of the conditioned airflow or the return airflow creates an air boundary, such that the air boundary and the solid boundary define the space within the environment, and
at least a portion of the conditioned airflow enters the space, and at least a portion of the return airflow exits the space, thereby conditioning the space.

2. The system of claim 1, wherein the solid boundary comprises a solid surface.

3. The system of claim 1, wherein the at least one air supply aperture comprises at least one hole, slit, slot, nozzle, vent, or register.

4. The system of claim 1, wherein the conditioned airflow has a flow rate from about 1 CFM to about 1000 CFM.

5. The system of claim 4, wherein the conditioned airflow is divided into a plurality of smaller airflows by the air supply aperture comprising a plurality of smaller air supply apertures.

6. The system of claim 5, wherein each of the plurality of smaller airflows has a gas velocity ranging from about 1 ft/sec to about 100 ft/sec.

7. The system of claim 1, wherein the conditioned airflow is conditioned by at least one of heating, cooling, humidifying, or dehumidifying.

8. The system of claim 1, wherein the at least one air return aperture comprises at least one hole, slit, slot, nozzle, vent, or register.

9. The system of claim 1, wherein the return airflow has a flow rate from about 1 CFM to about 1000 CFM.

10. The system of claim 1, wherein the portion of the conditioned airflow ranges from about 1 vol % to about 100 vol % of the conditioned airflow.

11. The system of claim 1, wherein the portion of the return airflow ranges from about 1 vol % to about 100 vol % of the return airflow.

12. The system of claim 1, wherein the space is configured to accommodate a human lying substantially in a prone position within at least a portion of the space.

13. A method for conditioning a space within an environment, the method comprising:
directing a conditioned airflow towards a solid boundary;
receiving a return airflow; and
defining the space by the conditioned airflow, the return airflow, and the solid boundary, wherein:
the conditioned airflow comprises a portion that is directed into the space and the return air flow comprises a portion that is received from the space, thereby conditioning the space.
